(19) United States
(12) Patent Application Publication
(10) Pub. No.: US 2021/0053316 A1
(43) Pub. Date: Feb. 25, 2021

(54) ECO-FRIENDLY SYNTHETIC PAPER AND METHOD FOR MANUFACTURING THE SAME

(71) Applicant: NAN YA PLASTICS CORPORATION, TAIPEI (TW)

(72) Inventors: TE-CHAO LIAO, TAIPEI (TW); SEN-HUANG HSU, TAIPEI (TW); CHAO-QUAN WU, TAIPEI (TW)

(21) Appl. No.: 16/833,736

(22) Filed: Mar. 30, 2020

(30) Foreign Application Priority Data
Aug. 20, 2019 (TW) 108129658

(51) Int. Cl. B32B 7/12; B32B 27/32; C09J 9/00; C09J 11/04; B32B 27/20

(52) U.S. Cl. CPC B32B 7/12; B32B 27/32; C08K 3/04; C09J 11/04; B32B 27/20; C09J 9/00

(57) ABSTRACT

An eco-friendly synthetic paper and a method for manufacturing the same are provided. The eco-friendly synthetic paper includes a light-shielding adhesive layer and two polypropylene-based resin layers. The light-shielding adhesive layer has a first surface and a second surface opposite to the first surface. The two polypropylene-based resin layers are respectively attached to the first surface and the second surface of the light-shielding adhesive layer. The light-shielding adhesive layer contains an adhesive component and a black colorant. The adhesive component is present in an amount between 35.9 wt % and 63.1 wt % of the total weight of the light-shielding bonding layer, and the black colorant is present in an amount between 12.9 wt % and 21.7 wt % of the total weight of the light-shielding bonding layer.

### CROSS-REFERENCE TO RELATED PATENT APPLICATION

This application claims the benefit of priority to Taiwan Patent Application No. 108129658 filed on Aug. 20, 2019. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a synthetic paper for being used in place of a natural paper, and more particularly to an eco-friendly synthetic paper and a method for manufacturing the same.

### BACKGROUND OF THE DISCLOSURE

In contrast to the growing demand for paper across the world, wood and plant fibers for papermaking have continued to decrease. In recent years, with the increase in environmental awareness, the development of synthetic papers that are to be used in place of natural papers has gradually received attention, so as to slow down the consumption of forest resources and protect the ecological environment. The synthetic paper is a plastic film paper having a texture similar to that of natural paper, and is made of polymer material(s) and auxiliary material(s) such as inorganic filler. The synthetic paper not only has the properties of plastics such as folding resistance, water resistance and corrosion resistance, but similar to natural paper, has good ink absorption ability and printing adaptability as well. Therefore, the synthetic paper has a wide range of uses.

The applicant has previously developed a number of patented technologies, all of which use organic resins such as a composition including polyethylene, polypropylene or polyester to form a plastic synthetic paper by co-extruding. The plastic synthetic paper has good performance on stiffness, shielding property, surface gloss and printing adaptability. However, the plastic synthetic paper has a certain degree of light transmission, and its resulting product such as an advertising board, after being printed on both sides thereof, may have blur patterns or texts due to the mutual interference of two printed patterns respectively formed on both sides. In addition, since the synthetic paper cannot effectively shield lights, a light leakage problem may occur, which may easily affect our daily lives.

In addition, conventional indoor sun shields generally use one or more metal or metal/plastic composite light shielding components (e.g., a light shielding sheet). However, the light shielding components cannot be recycled after being discarded. Although the light shielding components can shield sun light, they will absorb heat and cause excess consumption of energy relating to air conditioning.

### SUMMARY OF THE DISCLOSURE

In response to the above-referenced technical inadequacies, the present disclosure provides an eco-friendly synthetic paper having high light-shielding property and a method for manufacturing the same.

In one aspect, the present disclosure provides an eco-friendly synthetic paper which includes a light-shielding adhesive layer and two polypropylene-based resin layers. The light-shielding adhesive layer has a first surface and a second surface opposite to the first surface. The two polypropylene-based resin layers are respectively attached to the first surface and the second surface of the light-shielding adhesive layer. The light-shielding adhesive layer contains an adhesive component and a black colorant. The adhesive component is present in an amount between 35.9 wt % and 63.1 wt % of the total weight of the light-shielding bonding layer, and the black colorant is present in an amount between 12.9 wt % and 21.7 wt % of the total weight of the light-shielding bonding layer.

In certain embodiments, the adhesive component is at least one selected from polyurethane, acrylic, polyester, polyvinyl alcohol and ethylene vinyl acetate.

In certain embodiments, the black colorant is carbon black, titanium black or the combination thereof.

In certain embodiments, each of the polypropylene-based resin layers contains 63 wt % to 94.9 wt % of polypropylene and 0.1 wt % to 6 wt % of an ultraviolet absorber.

In certain embodiments, each of the polypropylene-based resin layers further contains 0 to 10 wt % of polyethylene.

In certain embodiments, each of the polypropylene-based resin layers further contains 5 wt % to 20 wt % of an inorganic filler.

In certain embodiments, the inorganic filler is at least one selected from titanium dioxide, calcium carbonate and barium sulfate.

In certain embodiments, each of the polypropylene-based resin layers further contains 0 to 1 wt % of an antioxidant.

In certain embodiments, the thickness of the light-shielding adhesive layer is between 4 μm and 8 μm, and the thickness of each of the polypropylene-based resin layers is between 60 μm and 120 μm.

In certain embodiments, the light-shielding adhesive layer has a visible light blocking rate of at least 99%, and the light-shielding adhesive layer has a peel strength greater than or equal to 250 g/2.5 cm relative to each of the polypropylene-based resin layers.

In one aspect, the present disclosure provides a method for manufacturing an eco-friendly synthetic paper, including: forming a first polypropylene-based resin layer; applying a coating material to the first polypropylene-based resin layer and curing the coating material so as to form a light-shielding adhesive layer; and forming a second polypropylene-based resin layer on the light-shielding adhesive layer, wherein the second polypropylene-based resin layer is laminated on the first polypropylene-based resin layer by the light-shielding adhesive layer. The light-shielding adhesive layer contains an adhesive component and a black colorant, the adhesive component is present in an amount between 35.9 wt % and 63.1 wt % of the total weight of the light-shielding bonding layer, and the black colorant is present in an amount between 12.9 wt % and 21.7 wt % of the total weight of the light-shielding bonding layer.

One of the advantages of the present disclosure is that the eco-friendly synthetic paper, in which the two polypropylene-based resin layers are respectively attached to the first surface and the second surface of the light-shielding adhesive layer and the light-shielding adhesive layer contains 35.9 wt % to 63.1 wt % of an adhesive component and 12.9 wt % to 21.7 wt % of a black colorant, can have a texture similar to a natural paper. In addition, two printed patterns respectively formed on both sides of the eco-friendly synthetic paper do not interfere with each other. Therefore, the two printed patterns can be clearly shown.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a schematic view of an eco-friendly synthetic paper of the present disclosure.

FIG. 2 is a schematic view showing a manufacturing process of the eco-friendly synthetic paper of the present disclosure.

FIG. 3 is a schematic view showing another manufacturing process of the eco-friendly synthetic paper of the present disclosure.

FIG. 4 is a flowchart of a method for manufacturing the eco-friendly synthetic paper of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

Unless defined otherwise, all technical and scientific terms used herein have the same meanings as commonly understood by one of ordinary skill in the art to which this invention belongs. As used herein, the singular forms “a,” “an,” and “the,” are intended to include the plural forms.

Unless indicated otherwise, all percentages disclosed herein are in weight percent. The upper and lower limits of these smaller ranges may independently be included in the smaller ranges and are also encompassed within the disclosure, subject to any specifically excluded limit in the stated range.

Synthetic papers have a wide range of applications, and at least include printed material, advertising boards, packages of items or foods and sun shields. Therefore, the present disclosure provides an eco-friendly synthetic paper that can be completely recycled and that can promote the realization of a circular economy and environmental protection. Furthermore, the eco-friendly synthetic paper of the present disclosure has properties such as a certain whiteness and brightness, good ink absorbing ability, high light-shielding property, high water resistance and high weather resistance, which are required for target applications.

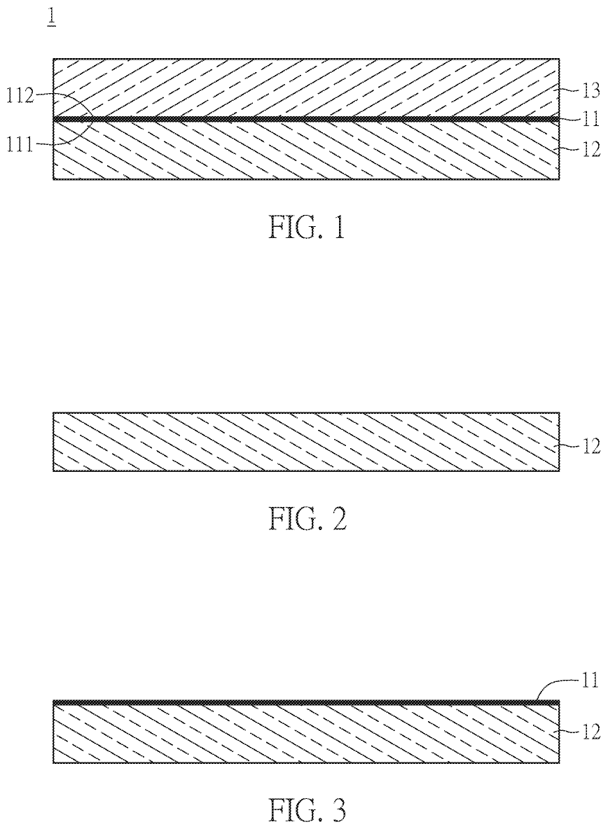

Referring to FIG. 1, the eco-friendly synthetic paper 1 of the present disclosure is a sandwich structure including a light-shielding adhesive layer 11, a first polypropylene-based resin layer 12 and a second polypropylene-based resin layer 13. The light-shielding adhesive layer 11 has a first surface 111 and a second surface 112. The first polypropylene-based resin layer 12 is attached to the first surface 111 (e.g., lower surface) of the light-shielding adhesive layer 11. The second polypropylene-based resin layer 13 is attached to the second surface 112 (e.g., upper surface) of the light-shielding adhesive layer 11.

In the present embodiment, the light-shielding adhesive layer 11 is provided with a black appearance and has good bonding ability relative to a target object. Accordingly, the first polypropylene-based resin layer 12 and the second polypropylene-based resin layer 13 can be laminated together by the light-shielding adhesive layer 11 for serving as paper top layers or surface layers. It is worth mentioning that when the first polypropylene-based resin layer 12 and the second polypropylene-based resin layer 13 serve as paper top layers, both sides of the eco-friendly synthetic paper 1 can be printed upon. In practice, two printed patterns respectively formed on the both sides of the eco-friendly synthetic paper 1 do not interfere with each other in the presence of the light-shielding adhesive layer 11. Therefore, the two printed patterns can be clearly shown.

More specifically, the thickness of the light-shielding adhesive layer 11 is between 4 μm and 8 μm. The light-shielding adhesive layer 11 contains an adhesive component and a black colorant. The adhesive component is at least one selected from polyurethane, acrylic, polyester, polyvinyl alcohol and ethylene vinyl acetate, and is present in an amount between 35.9 wt % and 63.1 wt % of the total weight of the light-shielding bonding layer 11. The black colorant is carbon black, titanium black or the combination thereof, and is present in an amount between 12.9 wt % and 21.7 wt % of the total weight of the light-shielding bonding layer 11. In the present embodiment, the black colorant is carbon black that is uniformly dispersed in the light-shielding bonding layer 11 in the form of particles having an average particle diameter between 0.3 μm and 1.2 μm. However, the above-described details are merely exemplary, and are not intended to limit the present disclosure.

It is worth mentioning that the thickness of the light-shielding bonding layer 11 and the amount present of the black colorant will affect the optical density of the light-shielding bonding layer 11. If the light-shielding bonding layer 11 has relatively higher optical density, it would have relatively better light-shielding ability. In certain embodiments, the thickness of the light-shielding bonding layer 11 can be 4 μm, 5 μm, 6 μm, 7 μm or 8 μm, and the amount present of the black colorant can be 14 wt %, 15 wt %, 16 wt %, 17 wt %, 18 wt %, 19 wt %, 20 wt % or 21 wt %. It is observed from test results that the light-shielding adhesive layer 11 has a visible light blocking rate of at least 99%, and the light-shielding adhesive layer 11 has a peel strength greater than or equal to 250 g/2.5 cm relative to the first and second polypropylene-based resin layers 12, 13.

The visible light transmittance of the light-shielding adhesive layer 11 was tested in accordance with the JIS K7705 standard by a testing machine (TC-HIII DPK from Tokyo Denshoku Co, Ltd.). The lower the visible light transmittance, the better the visible light blocking rate of the light-shielding adhesive layer 11.

The peel strength was tested by a universal tensile testing machine (QC508PA from Cometech Testing Machines Co., Ltd). For this test, the machine speed was 300 mm/min, the peeling direction was perpendicular to the ground surface, and the peeling angle was 180 degrees.

The light-shielding adhesive layer 11 can be formed of a coating material. The composition of the coating material includes a main agent present in an amount of 31.9 wt % to 57.9 wt %, a hardening agent present in an amount of 4 wt % to 5.2 wt %, a black colorant present in an amount of 12.9 wt % to 21.7 wt %, and a solvent present in an amount of 25.3 wt % to 41.2 wt %.

The thickness of each of the first polypropylene-based resin layer 12 and the second polypropylene-based resin layer 13 is between 60 μm and 120 μm. Each of the first polypropylene-based resin layer 12 and the second polypropylene-based resin layer 13 contains a main resin, an inorganic filler and at least one functional additive. The main resin includes 63 wt % to 94.9 wt % of polypropylene. In order to enable the synthetic paper to have a suitable softness or hardness, the main resin can include 63 wt % to 94.9 wt % of polypropylene and 0 to 10 wt % of polyethylene. However, the above-described details are merely exemplary, and are not intended to limit the present disclosure. It is worth mentioning that, in the presence of the first polypropylene-based resin layer 12 and the second polypropylene-based resin layer 13, the eco-friendly synthetic paper 1 of the present disclosure can have a texture similar to that of a natural paper.

Said polypropylene may be a polypropylene homopolymer (PP-H), a polypropylene block copolymer (PP-B) and a polypropylene random copolymer (PP-R). Said polyethylene may be an ethylene homopolymer, an ethylene copolymer or the mixture thereof. In addition, said polyethylene, depending on the molecular structure and density, is divided into high density polyethylene (HDPE), low density polyethylene (LDPE), linear low density polyethylene (LLDPE) and metallocene polyethylene (mPE). In the present embodiment, the main resin is formed of polypropylene homopolymer and linear low density polyethylene, but is not limited thereto.

The term “ethylene homopolymer” refers to a polymer derived exclusively from ethylene. The molecular weight distribution, defined as the ratio of the weight average molecular weight to the number average molecular weight (Mw/Mn), of the ethylene homopolymer is from 1.5 to 3.5. The term “ethylene copolymer” refers to a polymer derived from ethylene and at least one additional functional monomer. In certain embodiments, the ethylene copolymer may be derived from ethylene and one or more alpha-olefins having 3 to 12 carbon atoms, and preferably 4 to 8 carbon atoms. Specific examples of the alpha-olefin include propylene, 1-butene, 1-hexene, 4-methyl-1pentene and 1-octene. In addition, the ethylene copolymer may be derived from ethylene and one or more unsaturated esters. Specific examples of the unsaturated ester include vinyl acetate, acrylate and methacrylate.

The inorganic filler is at least one selected from silicon oxide, titanium oxide, zirconia, aluminum oxide, aluminum hydroxide, calcium carbonate, magnesium carbonate and barium sulfate. The inorganic filler is present in an amount between 5 wt % and 20 wt % of the total weight of the first or second polypropylene-based resin layer 12, 13. It is worth mentioning that the inorganic filler is helpful for increasing the structural strength of the synthetic paper and reduce costs. In the present embodiment, in consideration of the texture and moisture resistance of the synthetic paper, the inorganic filler can be selected from at least one of titanium dioxide, calcium carbonate and barium sulfate. The inorganic filler is uniformly dispersed in the first or second polypropylene-based resin layer 12, 13 in the form of particles having an average particle diameter between 0.5 μm and 3 μm. However, the above-described details are merely exemplary, and are not intended to limit the present disclosure.

The at least one functional additive is added to provide desired property(ies) of the first or second polypropylene-based resin layer 12, 13. In the present embodiment, the at least one functional additive can be an antioxidant, an ultraviolet absorber or the combination thereof, such that the synthetic paper can have good weather resistance required for the synthetic paper applied to an advertising board. The ultraviolet absorber is present in an amount between 0.1 wt % and 6 wt % of the total weight of the first or second polypropylene-based resin layer 12, 13. The antioxidant is present in an amount between 0 and 1 wt % of the total weight of the first or second polypropylene-based resin layer 12, 13. Specific examples of the ultraviolet absorber include nickel quenchers, oxanilides, benzotriazoles, benzoates and benzophenones.

Specific examples of the antioxidant include hindered phenols, amines, triazoles, phosphites and thioesters. However, the above-described details are merely exemplary, and are not intended to limit the present disclosure.

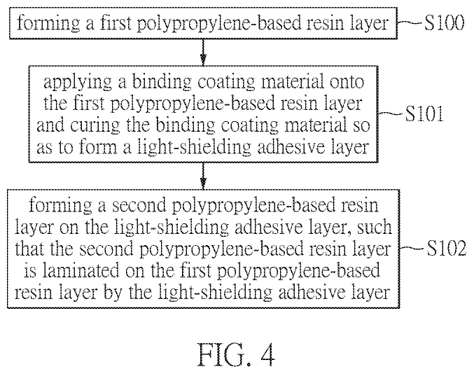

Referring to FIG. 4, which is to be read in conjunction with FIG. 1 to FIG. 3, the present disclosure further provides a method for manufacturing the eco-friendly synthetic paper. The method can be implemented by a roll to roll process, and is suitable for a large-scale and continuous production, which is beneficial for increasing the production efficiency and reducing the production costs. In this embodiment, the method firstly begins with step S100 of forming a first polypropylene-based resin layer 12. In the step S100, the composition of the first polypropylene-based resin layer 12 includes a main resin, an inorganic filler and at least one functional additive, which can be extruded into a continuous layered structure by an extruder (not shown) after being fully mixed. The first polypropylene-based resin layer 12 can serve as a carrier film and be moved along a process path by a feeder (not shown).

Next, the method proceeds to step S101 of applying a binding coating material onto the first polypropylene-based resin layer 12 and curing the binding coating material so as to form a light-shielding adhesive layer 11. In the step S101, the binding coating material includes a main agent, a hardening agent, a black colorant and a solvent. The binding coating material can be formed into a coating solution and applied to a surface of the first polypropylene-based resin layer 12 by a coater (not shown) arranged on the process path. Subsequently, the binding coating material can be heat treated at a suitable temperature to be dried and cured, thereby forming the light-shielding adhesive layer 11.

Next, the method proceeds to step S102 of forming a second polypropylene-based resin layer 13 on the light-shielding adhesive layer 11, such that the second polypropylene-based resin layer 13 is laminated on the first polypropylene-based resin layer 12 by the light-shielding adhesive layer 11. In the step S102, the composition of the second polypropylene-based resin layer 13 includes a main resin, an inorganic filler and at least one functional additive, which can be extruded into another continuous layered structure by another extruder (not shown) after being fully mixed. The second polypropylene-based resin layer 13 can be moved to the process path by another feeder (not shown) to be laminated on the first polypropylene-based resin layer 12. It is worth mentioning that the composition of the first polypropylene-based resin layer 12 can be the same as or different from that of the second polypropylene-based resin layer 13.

Finally, a receiver (not shown) is used to guide and collect the resulting synthetic paper at a predetermined rate and wind it into a roll. According to practical requirements, the synthetic paper can be post-processed (e.g., biaxially stretched) to have one or more desired mechanical properties before winding.

Table 1 lists representative examples of the light-shielding adhesive layer 11 of the present disclosure. However, these examples are not intended to limit the present disclosure.

TABLE 1

| | | Examples | | | | | | Comparative Examples | | |
|---|---|---|---|---|---|---|---|---|---|---|
| Items | | 1 | 2 | 3 | 4 | 5 | 6 | 1 | 2 | 3 |
| Main | Polyurethane | 43.5 | 50.5 | 43.1 | 43.5 | 43.1 | 43.1 | — | — | — |
| Resin | Acrylic | — | — | — | — | — | — | 50.5 | 43.5 | — |
| | Polyester | — | — | — | — | — | — | — | — | 50.5 |
| Hardening | Polyurethane hardening agent | 4.3 | 4 | 5.2 | 4.3 | 5.2 | 5.2 | — | — | — |
| agent | Acrylic hardening agent | — | — | — | — | — | — | 4 | 4.3 | — |
| | Polyester hardening agent | — | — | — | — | — | — | — | — | 4 |
| Solvent | EAC | 30.5 | 25.3 | 38.8 | 30.5 | 38.8 | 38.8 | 25.3 | 30.5 | 25.3 |
| Black | Carbon black | 0.3 | 0.8 | 1.2 | 0.3 | — | — | — | — | — |
| colorant | Carbon black pigment | 21.7 | 20.2 | 12.9 | 21.7 | — | — | — | — | — |
| | Iron oxide black | — | — | — | — | 20 | 60 | 20 | 60 | 20 |
| | Iron oxide black pigment | — | — | — | — | 21.7 | 21.7 | 20.2 | 21.7 | 20.2 |
| Property | Thickness of adhesive layer | 8 | 6 | 12 | 3 | 10 | 6 | 10 | 8 | 8 |
| comparison | Thickness uniformity | ◯ | ◯ | ◯ | ◯ | Δ | X | Δ | X | X |
| | Light transmittance | 0.05 | 0.1 | 0.03 | 1.1 | 0.5 | 0.6 | 0.8 | 0.7 | 1 |
| | Peeling strength relative to | 428 | 364 | 410 | 232 | 265 | 251 | 224 | 247 | 212 |
| | polypropylene-based resin layer | | | | | | | | | |
| | Dispersivity of black colorant | ◯ | ◯ | ◯ | ◯ | Δ | X | Δ | X | X |
| | Light blocking rate | 99.95 | 99.9 | 99.97 | 98.9 | 99.5 | 99.4 | 99.2 | 99.3 | 99 |

One of the advantages of the present disclosure is that the eco-friendly synthetic paper, in which the two polypropylene-based resin layers are respectively attached to the first surface and the second surface of the light-shielding adhesive layer and the light-shielding adhesive layer contains 35.9 wt % to 63.1 wt % of an adhesive component and 12.9 wt % to 21.7 wt % of a black colorant, can have a texture similar to a natural paper. In addition, two printed patterns respectively formed on the both sides of the eco-friendly synthetic paper do not interfere with each other. Therefore, the two printed patterns can be clearly shown.

Furthermore, the eco-friendly synthetic paper of the present disclosure has properties such as a certain whiteness and brightness, good ink absorbing ability, high light-shielding property, high water resistance and high weather resistance, which are required for target applications. The eco-friendly synthetic paper can be completely recycled and is helpful toward realizing a circular economy and environmental protection.

In addition, the method of the present disclosure for manufacturing the eco-friendly synthetic paper can be implemented by a roll to roll process, and is suitable for a large-scale and continuous production, which is beneficial for increasing the production efficiency and reducing the production costs.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An eco-friendly synthetic paper, comprising:
a light-shielding adhesive layer having a first surface and a second surface; and
two polypropylene-based resin layers respectively attached to the first surface and the second surface of the light-shielding adhesive layer;
wherein the light-shielding adhesive layer contains an adhesive component and a black colorant, the adhesive component is present in an amount between 35.9 wt % and 63.1 wt % of the total weight of the light-shielding bonding layer, and the black colorant is present in an amount between 12.9 wt % and 21.7 wt % of the total weight of the light-shielding bonding layer.

2. The eco-friendly synthetic paper according to claim 1, wherein the adhesive component is at least one selected from polyurethane, acrylic, polyester, polyvinyl alcohol and ethylene vinyl acetate.

3. The eco-friendly synthetic paper according to claim 1, wherein the black colorant is carbon black, titanium black or the combination thereof.

4. The eco-friendly synthetic paper according to claim 1, wherein each of the polypropylene-based resin layers contains 63 wt % to 94.9 wt % of polypropylene and 0.1 wt % to 6 wt % of an ultraviolet absorber.

5. The eco-friendly synthetic paper according to claim 4, wherein each of the polypropylene-based resin layers further contains 0 to 10 wt % of polyethylene.

6. The eco-friendly synthetic paper according to claim 4, wherein each of the polypropylene-based resin layers further contains 5 wt % to 20 wt % of an inorganic filler.

7. The eco-friendly synthetic paper according to claim 6, wherein the inorganic filler is at least one selected from titanium dioxide, calcium carbonate and barium sulfate.

8. The eco-friendly synthetic paper according to claim 4, wherein each of the polypropylene-based resin layers further contains 0 to 1 wt % of an antioxidant.

9. The eco-friendly synthetic paper according to claim 1, wherein the thickness of the light-shielding adhesive layer is between 4 μm and 8 μm, and the thickness of each of the polypropylene-based resin layers is between 60 μm and 120 μm.

10. The eco-friendly synthetic paper according to claim 1, wherein the light-shielding adhesive layer has a visible light blocking rate of at least 99%, and the light-shielding adhesive layer has a peel strength greater than or equal to 250 g/2.5 cm relative to each of the polypropylene-based resin layers.

11. A method for manufacturing an eco-friendly synthetic paper, comprising:
forming a first polypropylene-based resin layer;
applying a coating material onto the first polypropylene-based resin layer and curing the coating material so as to form a light-shielding adhesive layer; and
forming a second polypropylene-based resin layer on the light-shielding adhesive layer, wherein the second polypropylene-based resin layer is laminated on the first polypropylene-based resin layer by the light-shielding adhesive layer;
wherein the light-shielding adhesive layer contains an adhesive component and a black colorant, the adhesive component is present in an amount between 35.9 wt % and 63.1 wt % of the total weight of the light-shielding bonding layer, and the black colorant is present in an amount between 12.9 wt % and 21.7 wt % of the total weight of the light-shielding bonding layer.
